(19) United States
(12) Patent Application Publication
(10) Pub. No.: US 2009/0101834 A1
(43) Pub. Date: Apr. 23, 2009

(54) Ion beam extraction assembly in an ion implanter

(75) Inventors: Lee Spraggon, East Sussex (GB); Adrian Murrell, West Sussex (GB)

Correspondence Address: APPLIED MATERIALS, INC., P. O. BOX 450A, SANTA CLARA, CA, 95052, US

(73) Assignee: APPLIED MATERIALS, INC.

(21) Appl. No.: 11/976,322

(22) Filed: Oct. 23, 2007

(51) Int. Cl. H01J 27/00

(52) U.S. Cl. 250/423 R; 250/492.21

(57) ABSTRACT

The present invention relates to an ion beam extraction assembly for use in an ion beam generation apparatus such as those used, for example, in an ion implanter. An ion beam extraction assembly is provided for mounting within an ion beam generating apparatus comprising an ion source such that the extraction assembly is operable to extract ions from the ion source as an ion beam. The extraction assembly comprises an electrode assembly separate from the ion source, an electrode of the electrode assembly defining at least partly a path through the extraction assembly for passage of an ion beam. At least a part of the electrode assembly adjacent the path is tungsten and at least a part of the electrode assembly that is remote from the path is formed from a less expensive and/or lighter material.

### FIELD OF THE INVENTION

The present invention relates to an ion beam extraction assembly for use in an ion beam generation apparatus such as those used, for example, in an ion implanter.

### BACKGROUND OF THE INVENTION

Ion implantation techniques, e.g. for modifying the electrical conductivity properties of semiconductor materials, are known in the manufacture of integrated circuit structures in semiconductor wafers. Such ion implanters generally comprise an ion beam generation apparatus having a source of ions of the element to be implanted in the semiconductor wafer, and an extraction assembly for extracting ions from the source and forming a beam of the extracted ions. The ion beam so produced is then passed through a mass analyser and selector for selecting a particular species of ions in the ion beam for onward transmission for implantation in the wafer or target substrate.

The extraction assembly may be a triode extraction assembly, so called because it involves an arrangement of three electrodes. A triode assembly requires mechanical adjustment of the electrodes to be made in order to optimise or “tune” the ion source for maximum beam current on the wafer.

In an attempt to simplify this “tuning” operation, it has been proposed to use a tetrode assembly having four electrodes. Such an assembly is disclosed in U.S. Pat. No. 6,559,454.

The tetrode assembly has four electrodes, each having at least one aperture to allow the passage of the ion beam. The first electrode is a source electrode which generally forms one wall of an arc chamber of the ion source and is at the same potential as the arc chamber. The second electrode immediately adjacent to the first electrode is an extraction electrode which is set at a potential to attract ions out of the ion source. The third electrode is a suppression electrode which operates to prevent electrodes in the ion beam downstream of a fourth, ground electrode from being drawn into the ion source. This ground electrode restricts the penetration of the electric fields between the ground electrode and the ion source into the region downstream of the ground electrode.

The advantage of a tetrode structure is that the potential between the arc chamber and the extraction electrode can be set independently of the potential between the ion source and the ground electrode. In this way, the energy of the ion beam emerging from the extraction assembly can be determined independently of the potential at which the ions are initially extracted from the arc chamber. This permits the extraction efficiency of the ion source to be optimised and simplifies the “tuning” of the ion source for maximum beam currents.

In order to provide flexibility for use with a range of ion beam energies, from high-energy beams to low-energy beams, a variable separation between the extraction and suppression electrodes is proposed by U.S. Pat. No. 6,559,454. With this arrangement, the size of the gap between the extraction and suppression electrodes can be decreased for low-energy beams and increased for high-energy beams (to reduce the chances of arcing due to the required higher acceleration voltage difference).

Further, as changing the gap between the extraction and suppression electrodes alters the focussing effect of the electric field, this arrangement allows better control of the beam shape over a range of beam energies.

The suppression and ground electrodes may also be moveable relative to the source and extraction electrodes in a lateral direction perpendicular to the beam direction. This provides additional control of the steering of the beam into the subsequent components of the ion implanter.

The aperture in each electrode is generally an elongate slot. There is a tendency for space-charge expansion to cause the beam to blow up in the direction of elongation of the slot. This causes increased beam strike on the electrodes, and hence a loss of beam current. In order to overcome this problem, at least one of the electrodes may be concave facing away from the ion source in the plane containing the direction of beam travel, and the direction in which the slot is elongate. The concave electrode is often the extraction electrode. This curvature focuses the beam down as it passes through the extraction electrode and into the analyser magnet. The degree of curvature is preferably such that it counteracts the space-charge expansion of the beam in this plane. The source electrode may be concave in addition to the extraction electrode.

U.S. Pat. No. 6,559,454 suggests that both source and extraction electrodes are curved with a common radius of curvature. U.S. Pat. No. 6,777,882 suggests an improvement may be obtained by having source and extraction electrodes with different radii of curvature and that are arranged concentrically.

Pentode assemblies are also known. In such assemblies, a further electrode, termed the acceleration electrode is positioned downstream of the extraction electrode to provide an intermediate potential level between the extraction electrode and the ground electrode. This is beneficial in suppressing arc discharge.

A common feature of the above electrode arrangements is that the end electrode in the downstream position is subject to ion beam erosion and is a significant source of low energy drift particles in the ion beam. For example, the tendency for the ion beam to diverge means that the last electrode sees the highest risk of beam strike. Any beam strike may cause material to be sputtered from the electrode. These contaminants can become entrained within the ion beam. These particles may be implanted in a substrate, either as a result of being directly transported within the ion beam or as a result of one or more cycles of deposition on downstream components followed by subsequent sputtering. Typically, the downstream electrode is a ground electrode, as described above with respect to tetrode assemblies.

### SUMMARY OF THE INVENTION

Against this background, the present invention resides in an ion beam extraction assembly for mounting within an ion beam generating apparatus comprising an ion source such that the extraction assembly is operable to extract ions from the ion source as an ion beam. The extraction assembly comprises an electrode assembly separate from the ion source. An electrode of the electrode assembly defines at least partly a path through the extraction assembly for passage of an ion beam. At least a part of the electrode assembly adjacent the path is tungsten and at least a part of the electrode assembly that is remote from the path is formed from a different material.

One way of overcoming the problem of contamination from beam strike on electrodes within an extraction assembly is to use tungsten. However, such an arrangement would be very heavy, and also very expensive.

Advantageously, the present invention provides a combination of tungsten and other parts, such as graphite parts. Tungsten is used for parts of the electrode that are prone to beam strike, while graphite or another material is used for parts of the support that are far less prone to beam strike. Thus the benefit of a tungsten electrode is realised, but in an arrangement that may have significant weight and cost savings over an all tungsten arrangement. Thus, the different material should be less expensive than tungsten and/or lighter.

Preferably, all of an edge of the electrode that defines the ion beam path is formed from tungsten. This is because it is this part of the electrode that is most likely to see beam strike.

Optionally, the electrode assembly comprises a composite electrode including a first tungsten portion adjacent the ion beam path and a second portion remote from the ion beam path formed of the different material. For example, the electrode assembly may comprise an electrode body formed of the different material that is provided with a tungsten cap that fits over a portion of the electrode body adjacent the ion beam path.

The electrode assembly may comprise an electrode mounted to a support that, optionally, may be formed of a material other than tungsten.

Preferably, the extraction assembly comprises a tungsten electrode mounted to a support. The support may be made from a single material, e.g. graphite. Typically, weight savings of more than 50% may be achieved with such an arrangement of a tungsten electrode and graphite support.

Optionally, the extraction assembly may comprise a plurality of electrode components that together form the electrode, and wherein each electrode component is mounted to the support. The plurality of electrode components may be mounted to a common support. For example, a pair of common supports may be used to mount the plurality of electrode components, with a support disposed at either side of the extraction assembly. The electrode components may span the width of the extraction assembly, such that each electrode component is supported by both supports. Such electrode components may have apertures provided therein to allow passage of the ion beam along its path. Alternatively, pairs of opposed electrode components may be arranged to define the ion beam's path therebetween. In this arrangement, each electrode component may be supported by only a single support, depending upon which side of the extraction assembly they reside.

Preferably, the support comprises angled slots arranged to receive the electrode components and to support each of the electrode components at a desired angle. Optionally, the support and each electrode component are provided with complementary features for setting the position of each electrode component. These may comprise lugs that are received within complementary slots. The lugs may be provided on the electrode components or the supports.

Graphite has been mentioned above as a suitable choice for the different material, for the part of the electrode assembly remote from the ion beam path or for the support. Other suitable choices include stainless steel and Inconel®.

Optionally, the extraction assembly comprises a series of electrodes defining a path through which an ion beam is intended to pass, and wherein the electrode is disposed at an end of the series. The extraction assembly may comprise a tetrode arrangement, although other arrangements such as triodes and pentodes are contemplated.

The present invention also extends to an ion beam generating apparatus comprising an ion source and any of the ion beam extraction assemblies described above. The extraction assembly may be mounted within the ion beam generating apparatus such that the extraction assembly is operable to extract ions from the ion source as an ion beam.

Optionally, the extraction assembly comprises a source electrode and the tungsten electrode, the source electrode being electrically connected so as to operate at the same voltage as the ion source and having an aperture provided therein for allowing passage of the ion beam from the ion source. The next electrode downstream of the source electrode may be an extraction electrode electrically biased to attract ions from the ion source. The next electrode downstream of the extraction electrode may be a suppression electrode electrically biased to suppress electrons from travelling upstream to the ion source. The next electrode downstream of the suppression electrode may be a ground electrode electrically by being biased to suppress electric fields generated by the extraction assembly from extending downstream of the ground electrode. Any or all of the extraction electrode, the suppression electrode or the ground electrode may correspond to the electrode of the electrode assemblies described above.

As will be appreciated, the electrodes and electrode components described above may be formed as a single piece of tungsten or may comprise any of the composite designs described above, e.g. a graphite electrode body fitted with a tungsten cap.

The present invention also extends to an ion implanter comprising any of the ion beam generating apparatuses described above.

### BRIEF DESCRIPTION OF THE DRAWINGS

An example of the present invention will now be described with reference to the accompanying drawings, in which:

FIG. 1 is a schematic view of an ion implanter incorporating the present invention;

FIG. 2 is a schematic plan view illustrating the arrangement of electrodes of FIG. 1;

FIG. 3 is a schematic view along line III-III in FIG. 2;

FIG. 4 is a schematic drawing showing the mounting of the extraction electrode in greater detail than as shown in FIG. 2;

FIG. 5 corresponds to FIG. 2, and shows an electrode arrangement including an electrostatic lens;

FIG. 6 is a perspective view of one half of a ground electrode assembly according to an embodiment of the present invention;

FIGS. 7 and 8 are perspective views of the electrodes of FIG. 6;

FIG. 9 is a perspective view of the end support of FIG. 6;

FIG. 10 is a detail from FIG. 9;

FIG. 11 shows the ground electrode assembly of FIG. 6 mounted within an ion beam generating assembly;

FIG. 12 is a perspective view of an electrode assembly according to a further embodiment of the present invention; and

FIG. 13 is an exploded view of the electrode assembly of FIG. 12.

### DETAILED DESCRIPTION OF THE INVENTION

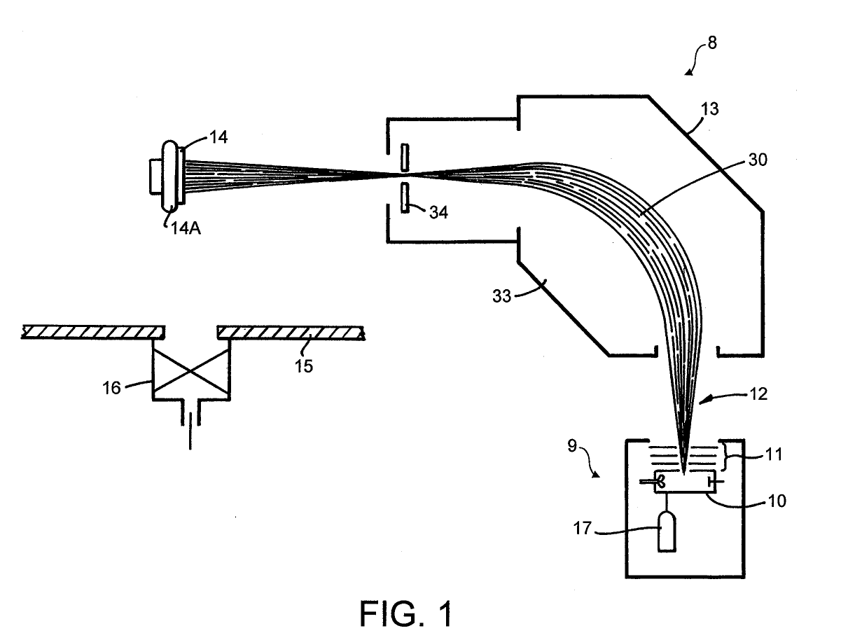

Referring to FIG. 1, a conventional ion implanter is shown schematically at 8. The ion implanter 8 includes ion beam generation apparatus 9. The ion beam generation apparatus 9 comprises an ion source 10 with an extraction assembly 11. The extraction assembly 11 extracts and directs an ion beam 12 through an ion mass selector 13 to impinge on a wafer 14 mounted on a wafer holder 14A. As is well known to workers in this field, the above elements of the ion implanter 8 are housed in a vacuum housing of which a part 15 only is illustrated in FIG. 1. The vacuum housing may be evacuated by a vacuum pump 16.

The ion source 10 may comprise any known ion source such as a Freeman source, a Bernas source or an indirectly heated cathode source. The ion source 10 comprises an arc chamber which is fed a supply of a feed gas containing a desired dopant, ions of which are to be implanted in the wafer 14. The feed gas may be supplied to the arc chamber in gaseous or vapour form, e.g. from a gas bottle 17.

The extraction assembly 11 comprises a number of electrodes located immediately adjacent the front of an arc chamber of the ion source 10 so as to extract ions from the arc chamber through an exit aperture in the front face.

The ion mass selector 13 illustrated in FIG. 1 comprises a magnetic sector mass analyser 33 operating in conjunction with a mass selecting slit 34. The magnetic analyser 33 comprises a region of uniform magnetic field in the direction perpendicular to the plane of the paper in FIG. 1. In such a magnetic field, all ions of constant energy and having the same mass-to-charge ratio will describe circular paths of uniform radius. The radius of curvature of the path is dependent on the mass-to-charge ratio of the ions, assuming uniform energy.

As is well known for such magnetic sector analysers, the geometry of such paths tends to bring a cone of ion paths emanating from an origin focus outside the entrance aperture of the analyser 33, back to a focal point beyond the exit aperture of the analyser 33. As illustrated in FIG. 1, the origin focus or point of origin of the central beam 30 is a point close to, typically just inside, the exit aperture of the arc chamber of the ion source 10. The beam 30 is brought to a focus in the plane of the mass selection slit 34 beyond the exit aperture of the analyser 33.

In FIG. 1, the beam 30 is drawn showing only ions of a single mass/charge ratio, so that the beam 30 comes to a single focus at the aperture of the slit 34, so that the beam of ions of this mass/charge ratio can pass through the slit 34 towards the wafer 14. In practice, the beam 30 emitted by the ion source 10 will also contain ions of different mass/charge ratio from those desired for implantation in the wafer 14 and these undesired ions will be brought to a focus by the analyser 33 at a point in the plane of the slit 34 either side of the position of the slit 34, and will therefore be prevented from travelling on towards the wafer 14. The analyser 33 thus has a dispersion plane in the plane of the drawing.

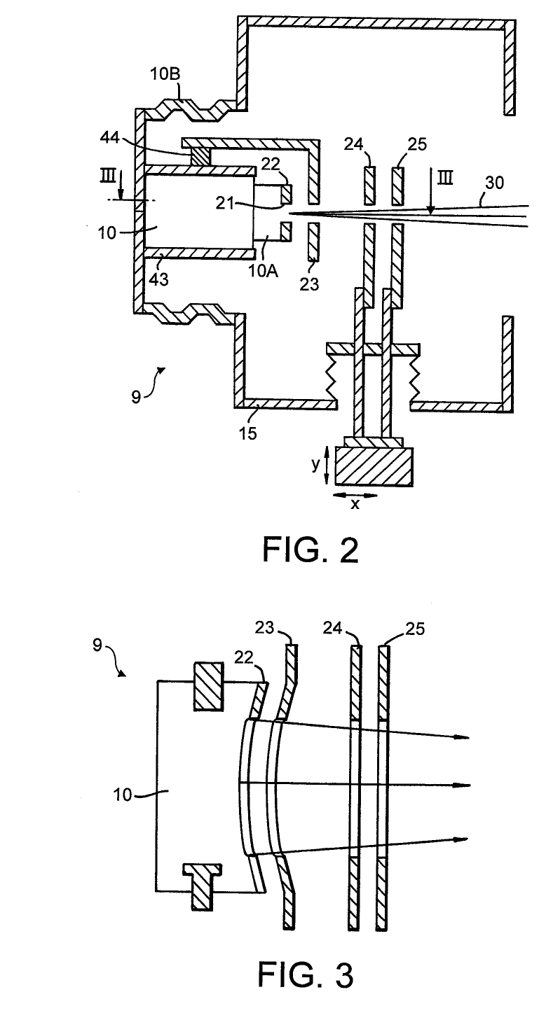

Referring to FIGS. 2 and 3, the ion beam generation assembly 9 is illustrated schematically. The ion source 10 comprises an arc chamber 10A mounted to housing 15 by arms 43 as more fully described with reference to FIG. 2. A bushing 10B acts as an insulator to isolate the ion source 10 from the remainder of the housing 15. Ions formed in the arc chamber 10A are extracted from the ion source 10 through an exit aperture 21 in a front face 22 of the ion source 10. The front face 22 of the ion source 10 forms a first apertured source electrode 22 at the potential of the ion source 10 forming part of the extraction assembly 11 (FIG. 1). The rest of the extraction assembly 11 is illustrated in FIG. 2 by extraction, suppression and ground apertured electrodes 23, 24 and 25 respectively. Each of the apertured electrodes 23, 24 and 25 comprise a single electrically conductive plate having an aperture through the plate to allow the ion beam emerging from the ion source 10 to pass through. Each aperture has an elongate slot configuration with the direction of elongation being perpendicular to the plane in FIG. 2 and in the plane of FIG. 3.

For a beam of positive ions, the ion source 10 is maintained by a voltage supply at a positive voltage relative to ground. The ground electrode 25 restricts the penetration of the electric fields between the ground electrode 25 and the ion source 10 into the region to the right (in FIG. 2) of the ground electrode 25. The energy of the ion beam 30 emerging from the extraction assembly is determined by the voltage supplied to the ion source 10. A typical value for this voltage is 20 kV, providing an extracted beam energy of 20 keV. However extracted beam energies of 80 keV and higher, or 0.5 keV or lower may also be contemplated. To obtain higher or lower voltages, it is a matter of raising or lowering respectively the source voltage.

The suppression electrode 24 is biased by a voltage supply to a negative potential relative to ground. The negatively-biased suppression electrode 24, operates to prevent electrons in the ion beam 30 downstream of the ground electrode 25 (to the right in FIG. 2) from being drawn into the extraction region and into the ion source 10. As is known to workers in this field, it is important to minimise the loss of electrons from the ion beam 30 in zero electric field regions, so as to maintain ion beam neutralisation.

For a beam of positive ions, the extraction electrode 23 is maintained by a voltage supply at a potential below the potential of the ion source 10 to extract the ions from the ion source 10. The potential of the extraction electrode 23 would typically be below the potential of the suppression electrode 24 for a low energy beam and above the potential of the suppression electrode 24 for a high energy beam. In the former case, the ion beam 30 will decelerate between the extraction electrode 23 and the suppression electrode 24, while in the latter case it will accelerate here.

The extraction electrode 23, and the source electrode 22 are curved in the plane of the paper of FIG. 3 so as to be concave facing away from the ion source 10. The degree of curvature is sufficient to suppress any divergence of the beam in the direction perpendicular to the plane of the paper on FIG. 2.

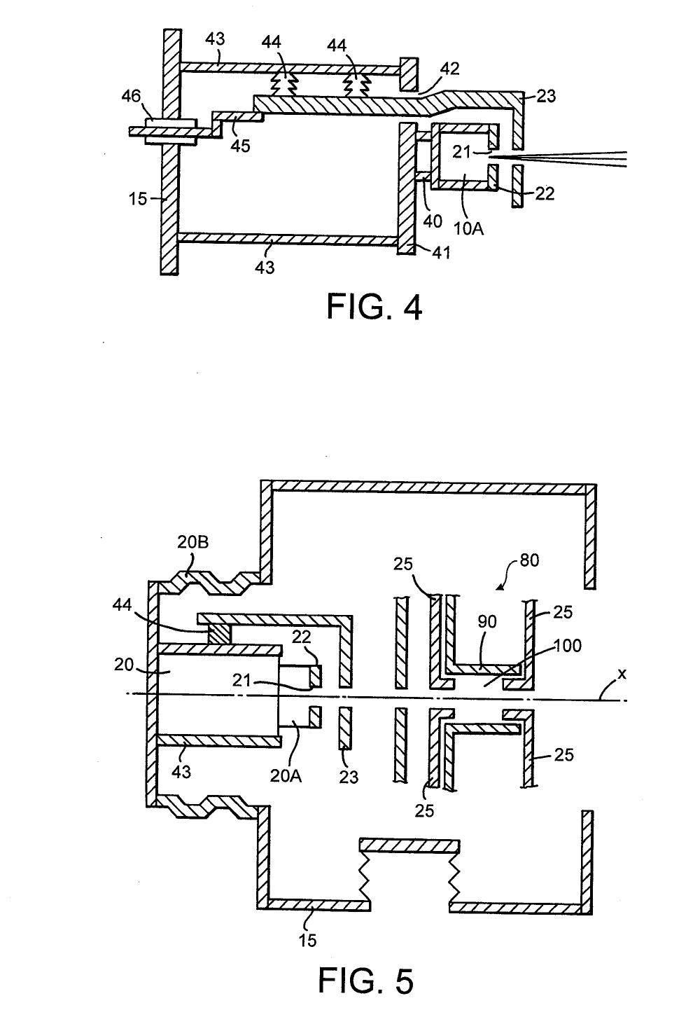

An example of how the extraction electrode 23 may be mounted is shown in more detail in FIG. 4. The arc chamber 10A is mounted by a pair of arms 40 to a circular disc 41 having a hole 42 through which the extraction electrode 23 penetrates. The circular disc 41 is itself supported by two arms 43 attached to the housing 15. The extraction electrode 23 is supported from one of the arms 43 by a pair of insulators 44. A lead 45 supported through the wall of the housing 15 by an insulator 46 connects the extraction electrode 23 to a voltage supply (not shown). It will be appreciated that the disc 41 provides shielding to prevent contaminants from being deposited on the electrode mounting. The extraction electrode 23 may be mounted so as to allow movement in the beam direction (arrow x) relative to the arc chamber 10A, for example as described in U.S. Pat. No. 6,777,882, the contents of which is incorporated in its entirety by reference.

The suppression electrode 24 and ground electrode 25 are mounted as shown in FIG. 2 so as to be moveable in the beam direction as represented by the arrow x and in a steering direction as represented by arrow y.

The suppression electrode 24 is mounted so as to be moveable relatively to the extraction electrode 23 in the direction of travel of the ion beam 30 as indicated by the arrow x. The apparatus can be “tuned” such that the gap between the extraction electrode 23 and suppression electrode 24 is larger, the larger the beam energy. The ground electrode 25 may be moveable in the direction 26 together with or independently of the suppression electrode 24. The electrodes 22-25 are further mounted, such that the suppression electrode 24 and ground electrode 25 are moveable relatively laterally in the direction of arrow 27, namely in the plane of the paper and perpendicular to the ion beam direction 26, relatively to the extraction electrode 23 and source electrode 22.

Further details pertaining to how the suppression electrode 24 and ground electrode 25 may be mounted may be found in U.S. Pat. No. 6,559,454, the contents of which is incorporated in its entirety by reference.

FIG. 5 generally corresponds to FIG. 2, but shows an ion beam extraction assembly 11 where the ground electrode 25 is replaced with an assembly that includes a ground electrode 25 as part of an electrostatic lens 80. The lens 80 comprises two cylinders of different diameters that are each coaxial about the ion beam axis x. The inner cylinder provides the ground electrode 25, while the outer cylinder 90 provides a lens electrode. The electrodes 15, 90 could be planar rather than cylindrical. The ground electrode 25 is provided with four slots 100. Each slot 100 is elongate along the ion beam axis x, and the slots 100 are equispaced about the cylinder 25. The field generated by the lens electrode 90 penetrates through the slots 100 to produce an electrostatic quadrupole. This lens arrangement 80 allows focusing in both z-axis and y-axis directions. Further details of such an arrangement may be found in U.S. Pat. No. 6,777,882.

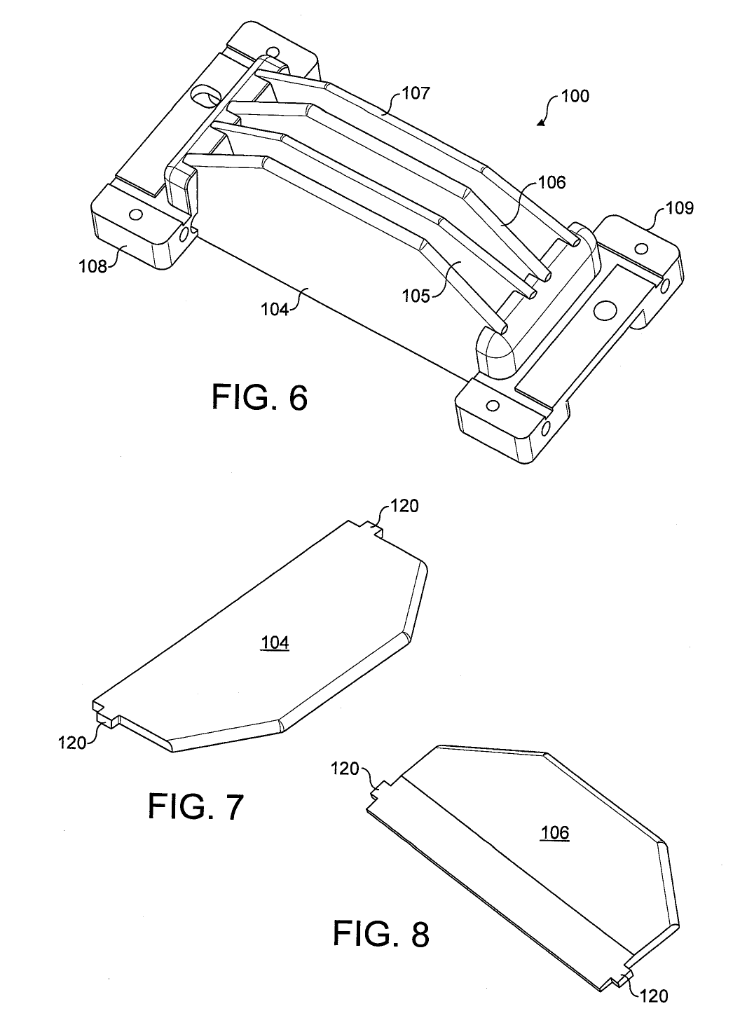

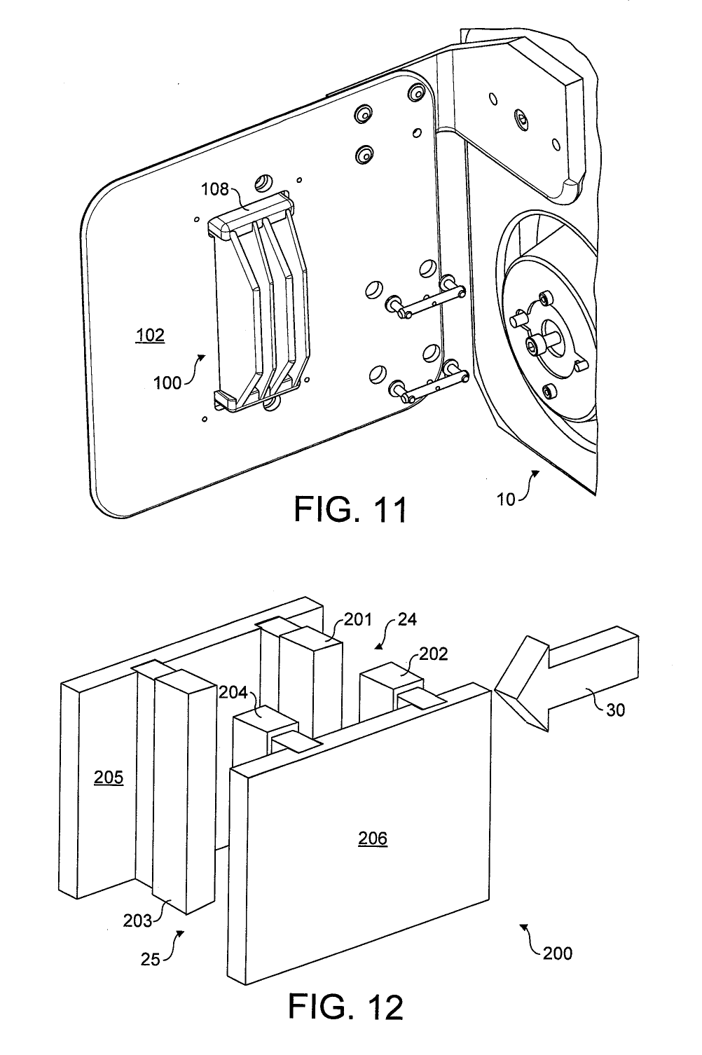

An electrode assembly 100 according to an embodiment of the present invention is shown in FIG. 6. In this embodiment, the electrode assembly comprises one half of a ground electrode 25. However, the electrode assembly 100 could function as either the extraction assembly 23 or suppression electrode 24. The ground electrode 25 comprises two halves, of which the ground electrode assembly 100 shown in FIG. 6 is one. FIG. 11 shows the ground electrode assembly 100 mounted on a plate 102 attached to the ion beam generation apparatus 9 relative to the ion source 10. Although not shown in FIG. 11, the ground electrode 25 comprises a second, like ground electrode assembly 100 disposed opposite the assembly 100 shown in FIG. 11 to form a symmetrical pair. The ion beam 30 passes between the assemblies 100. For the sake of clarity, the extraction electrode 23 and the suppression electrode 24 have been omitted from FIG. 11.

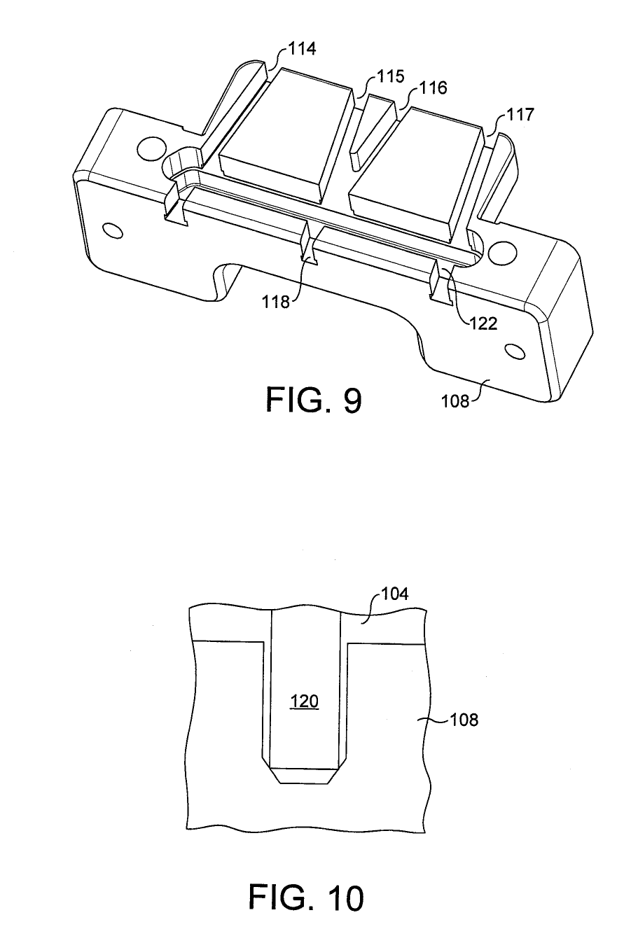

The ground electrode assembly 100 comprises four electrode plates 104-107 mounted to a pair of end supports 108-109. The provision of multiple electrode plates 104-107 is for better control of both high and low energy ion beams 30. Each electrode plate 104-107 is generally planar and is made from tungsten. The electrode plates 104-107 are received in slots 114-117 formed in the end supports 108-109 as best seen in FIG. 9. The end supports 108-109 are made from graphite. The slots 114-117 are angled to set the electrode plates 104-107 in an orientation to achieve a desired electrostatic field. The outer electrode plates 114 and 117 extend inwardly to converge towards the ion beam 30. In contrast, the inner electrode plates 115-116 diverge as they extend towards the ion beam 30. This divergence towards the ion beam 30 sees the inner electrode plates 105-106 converge within the end supports 108-109 such that slots 115-116 merge as shown at 118.

To fit within the merging slots 115-116, the inner electrode plates 105-106 have a tapering form. This can be seen in FIG. 8 where electrode plate 106 is shown; electrode plate 105 is of an identical design. This tapering form may be contrasted to the constant thickness of electrode plates 104 and 107. FIG. 7 shows electrode plate 104, although electrode plate 107 is of an identical design.

As can be seen from FIGS. 7 and 8, each electrode plate 104-107 is provided with a pair of lugs 120 that are sized and shaped to be received within channels 122 provided in end supports 108-109. The combination of the lugs 120 and channels 122 ensure correct positioning of the electrode plates 104-107. In addition, to prevent twisting of the electrode plates 104-107, the channel 122 provided in end support 108 has a chamfered base to receive a lug 120 with a correspondingly-shaped portion. These co-operating shapes ensure that the electrode plates 104-107 adopt and maintain a precise position rather than suffering from warping, e.g. due to thermal cycling. To ensure correct assembly of the ground electrode assembly 100, the two end supports 108-109 are indexed by their fixing hole positions.

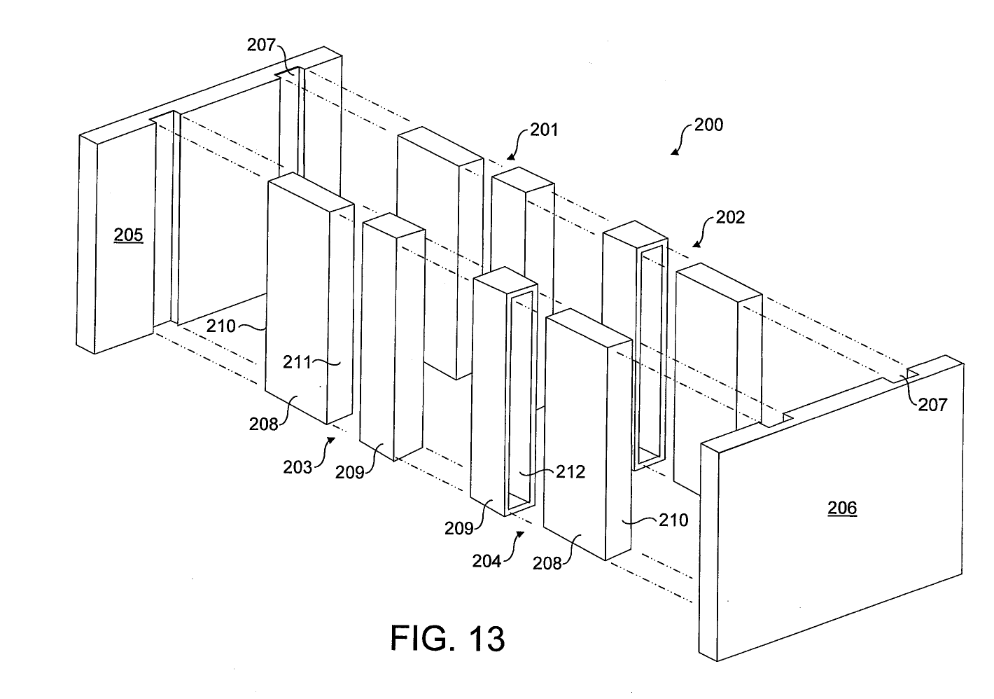

FIGS. 12 and 13 show another embodiment of the present invention. An electrode assembly 200 is shown assembled in FIG. 12 and as an exploded view in FIG. 13. The electrode assembly 200 comprises four electrode units 201-204. A first, upstream pair of opposed electrode units 201-202 (relative to the ion beam shown at 30) together comprise a suppression electrode 24 and a second, downstream pair of opposed electrode units 203-204 together comprise a ground electrode 25. The two pairs of opposed electrode units 201-204 form a pair of apertures through which the ion beam 30 passes as it travels through the ion beam extraction assembly 11. A pair of support members 205-206 are provided to hold the electrode units 201-204 in place. Suppression electrode unit 201 and ground electrode unit 203 are mounted to support member 205, and suppression electrode unit 202 and ground electrode unit 204 are mounted to support member 206. The electrode units 201-204 fit within slots 207 provided in the support members 205-206 and may be mounted to their respective support members 205-206 in any convenient manner, e.g. interference fit, bolt fastenings, screw fastenings, etc.

As can be seen most clearly from FIG. 13, each electrode unit 201-204 comprises an electrode body 208 and an electrode cap 209. Each electrode body 208 is positioned adjacent to one of the support members 205-206 such that an edge 210 of the electrode body 208 is received within a slot 207. Each electrode cap 209 fits over the edge 211 of an electrode body 208 that would otherwise define the aperture through which the ion beam 30 passes. Each electrode cap 209 is hollow with an open face 212 such that the electrode cap 209 may be placed over the edge 211 of the electrode body 208. The electrode caps 209 may be held in position on the electrode bodies 208 by any convenient means, e.g. a push fit, bolts, screws, etc. The attachment means should not be permanent as the electrode caps 209 will require removal from time to time, either for cleaning or for replacement.

In accordance with the present invention, the materials are carefully chosen for the components of the electrode assembly 200. Tungsten is chosen for the electrode caps 209 as these are most likely to see beam strike. The depth of the electrode caps 209 is chosen to ensure that all parts of the electrode units 201-204 likely to suffer from beam strike are covered by the tungsten electrode caps 209. As a result, the electrode bodies 208 do not need to be made from tungsten: instead, less expensive and lighter stainless steel is used, although other materials such as graphite or Inconel® may be used. Also, tungsten need not be used for the support members 205-206. An insulator is used for these support members because of the need to provide electrical insulation between the suppression electrode 24 and the ground electrode 25 (the electrical connections to the suppression electrode 24 and the ground electrode 25 are not shown in FIGS. 12 and 13 for the sake of clarity). Those skilled in the art will appreciate that other electrical arrangements may be used. For example, the support members 205-206 may be made of graphite and insulating sleeves may be used to join the electrode units 201-204 to the support members 205-206.

The electrode assembly 200 of FIGS. 12 and 13 is advantageous as only the parts exposed to the ion beam 30 are formed from tungsten. These electrode caps 209 are easily fitted and removed such that they may be cleaned or replaced periodically. The other components require servicing less frequently, if at all, and may be left in position when the electrode caps 209 are being refurbished or replaced.

This design may be simplified by replacing the electrode body 208/electrode cap 209 combination with a single tungsten electrode piece. For example, caps 209 may be omitted and the bodies 208 may be formed of tungsten. These symmetrical electrode pieces 208 may be reversed in slots 207, i.e. when one edge gets dirty the electrode piece 208 may be turned around to present a new clean edge to the ion beam 30.

Slots 207 may be made deeper so as to allow the position of the electrodes 201-204 to be varied, and hence the width of the aperture to be varied.

As will be appreciated by the person skilled in the art, variations may be made to the above embodiment without departing from the scope of the invention defined by the claims.

For example, the invention has been described with respect to an embodiment as a ground electrode 25 and an embodiment as a suppression electrode 24/ground electrode 25 assembly. However, the invention is applicable to any of the electrodes in the extraction assembly 11. Thus in the context of a tetrode arrangement, any combination of the source electrode 22, extraction electrode 23, suppression electrode 24 and ground electrode 25 may be arranged in accordance with the present invention, including any combination of these electrodes 22-25.

The ground electrode 25 has been described to include four pairs of electrode plates 104-107. However, the ground electrode 25 may comprise a single pair of electrode plates. Moreover, rather than using one or more pairs of opposed electrode plates that form the ion beam path therebetween, one or more single plate electrodes may be provided. Such single plate electrodes usually have a central aperture provided therein defining in part the ion beam's path. Often, such apertures are elongate.

FIG. 11 shows electrode plates 104-107 mounted to end support 108 that is in turn mounted to plate 102. However, electrode plates 104-107 may be mounted directly to the plate 102. For example, grooves may be formed in the plate 102 to receive the electrode plates 104-107. The electrode plates 104-107 may be held in place by any suitable means.

The extraction assemblies 11 described above may be adapted for use with any of the well-known ion implanter arrangements, including those described with respect to FIGS. 1 to 5. For example, the electrodes 22-25 may be fixed in position or may be mounted on mechanisms that allow their relative positions to be moved.

1. An ion beam extraction assembly for mounting within an ion beam generating apparatus comprising an ion source such that the extraction assembly is operable to extract ions from the ion source as an ion beam,
the extraction assembly comprising an electrode assembly separate from the ion source, an electrode of the electrode assembly defining at least partly a path through the extraction assembly for passage of an ion beam, and
wherein at least a part of the electrode assembly adjacent the path is tungsten and at least a part of the electrode assembly that is remote from the path is formed from a different material.

2. The extraction assembly of claim 1, wherein all of an edge of the electrode that defines the ion beam path is formed from tungsten.

3. The extraction assembly of claim 1, wherein the electrode assembly comprises a composite electrode including a first tungsten portion adjacent the ion beam path and a second portion remote from the ion beam path formed of the different material.

4. The extraction assembly of claim 3, wherein the electrode assembly comprises an electrode body formed of the different material that is provided with a tungsten cap that fits over a portion of the electrode body adjacent the ion beam path.

5. The extraction assembly of claim 1, wherein the electrode assembly comprises an electrode mounted to a support.

6. The extraction assembly of claim 5, wherein the support is formed of a material other than tungsten.

7. The extraction assembly of claim 6, wherein a tungsten electrode is mounted to the support.

8. The extraction assembly of claim 7, comprising a plurality of electrode components that together form the electrode, and wherein each electrode component is mounted to the support.

9. The extraction assembly of claim 8, wherein the plurality of electrode components are mounted to a common support.

10. The extraction assembly of claim 9, wherein a pair of common supports are used to mount the plurality of electrode components, with a support disposed at either side of the extraction assembly.

11. The extraction assembly of claim 9, wherein the support comprises angled slots arranged to receive the electrode components and to support each of the electrode components at a desired angle.

12. The extraction assembly of claim 9, wherein the support and each electrode component are provided with complementary keying features, the keying features being different for each electrode component.

13. The extraction assembly of claim 1, comprising a series of electrodes defining a path through which an ion beam is intended to pass, and wherein the electrode is disposed at an end of the series.

14. The extraction assembly of claim 13, wherein the extraction assembly comprises a tetrode arrangement.

15. The extraction assembly of claim 1, wherein the different material is graphite, stainless steel or Inconel®.

16. An ion beam generating apparatus comprising an ion source and the ion beam extraction assembly of any preceding claim mounted within the ion beam generating apparatus such that the extraction assembly is operable to extract ions from the ion source as an ion beam.

17. The apparatus of claim 16, wherein the extraction assembly comprises a source electrode and the electrode, the source electrode being electrically connected so as to operate at the same voltage as the ion source and having an aperture provided therein for allowing passage of the ion beam from the ion source.

18. The apparatus of claim 17, wherein the next electrode downstream of the source electrode is an extraction electrode electrically biased to attract ions from the ion source, the next electrode downstream of the extraction electrode is a suppression electrode electrically biased to suppress electrons from travelling upstream to the ion source, and the next electrode downstream of the suppression electrode is operated as a ground electrode electrically by being biased to suppress electric fields generated by the extraction assembly from extending downstream of the ground electrode.

19. The apparatus of claim 18, wherein the electrode of the electrode assembly is any of the group of the extraction electrode, the suppression electrode or the ground electrode.

20. An ion implanter comprising the ion beam generating apparatus of claim 16.
